(19) United States
(12) Patent Application Publication
(10) Pub. No.: US 2012/0159449 A1
(43) Pub. Date: Jun. 21, 2012

(54) Call Stack Inspection For A Thread Of Execution

(75) Inventors: Jeremy A. Arnold, Rochester, MN (US); Scott A. Moore, Rochester, MN (US); Gregory A. Olson, Rochester, MN (US); Eric J. Stec, Rochester, MN (US)

(73) Assignee: INTERNATIONAL BUSINESS MACHINES CORPORATION, Armonk, NY (US)

(21) Appl. No.: 12/968,397

(22) Filed: Dec. 15, 2010

(51) Int. Cl. G06F 9/44

(52) U.S. Cl. 717/125; 717/127; 717/128

(57) ABSTRACT

Call stack inspection for a thread of execution, including, for each stack frame in the call stack, beginning with the stack frame at the top of the call stack: inspecting the stack frame; determining whether the stack frame was present in the call stack on a previous inspection of the call stack; if the stack frame was not present on a previous inspection, indicating in the stack frame the stack frame's presence on the current inspection of the call stack; and if the stack frame was present on a previous inspection, notifying a user.

### BACKGROUND OF THE INVENTION

1. Field of the Invention

The field of the invention is data processing, or, more specifically, methods, apparatus, and products for call stack inspection for a thread of execution.

2. Description of Related Art

In software execution environments today, call stacks generally store information regarding active subroutines of a thread of execution. From time to time, a user may inspect a call stack to gather data describing stack frames of the call stack for analysis. Software developers, for example, may inspect call stacks to aid in software development. Current methods of call stack inspections, however, yield limited, if any, means by which such a user may determine whether stack frames in one inspection were present in the call stack on a previous inspection.

### SUMMARY OF THE INVENTION

Methods, apparatus, and products for call stack inspection for a thread of execution are disclosed that include for each stack frame in a call stack of a thread of execution: inspecting the stack frame; determining whether the stack frame was present in the call stack on a previous inspection of the call stack; if the stack frame was not present on a previous inspection, indicating in the stack frame the stack frame's presence on the current inspection of the call stack; and if the stack frame was present on a previous inspection, notifying a user.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for call stack inspection for a thread of execution according to embodiments of the present invention.

FIG. 2 sets forth a flow chart illustrating an exemplary method for call stack inspection for a thread of execution according to embodiments of the present invention.

FIG. 3 sets forth a flow chart illustrating a further exemplary method of call stack inspection for a thread of execution according to embodiments of the present invention.

FIG. 4 sets forth a flow chart illustrating a further exemplary method of call stack inspection for a thread of execution according to embodiments of the present invention.

FIG. 5 sets forth a flow chart illustrating a further exemplary method of call stack inspection for a thread of execution according to embodiments of the present invention.

### DETAILED DESCRIPTION OF EXEMPLARY EMBODIMENTS

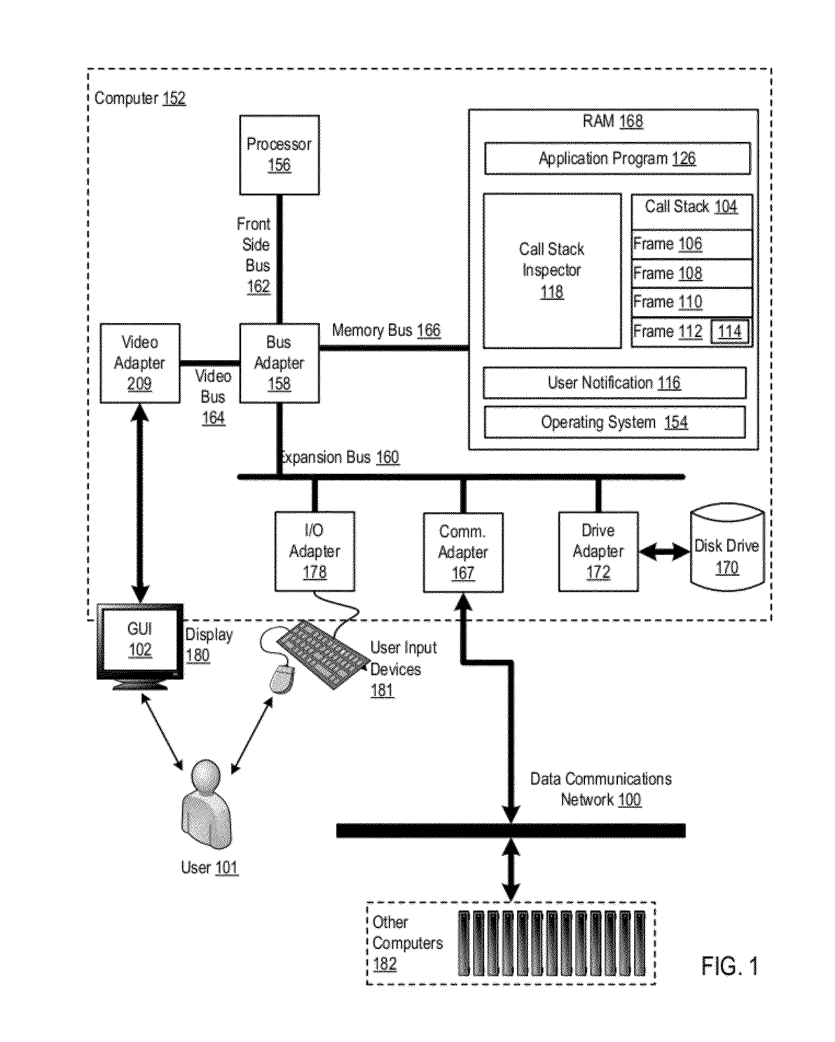

Exemplary methods, apparatus, and products for call stack inspection for a thread of execution in accordance with the present invention are described with reference to the accompanying drawings, beginning with FIG. 1. FIG. 1 sets forth a block diagram of a system for call stack inspection for a thread of execution according to embodiments of the present invention. A thread of execution as the term is used in this specification refers to the smallest unit of processing that can be scheduled by an operating system. A thread generally results from a fork of a computer program into two or more concurrently running tasks. The implementation of threads and processes differs from one operating system to another, but in most cases, a thread is contained inside a process. Multiple threads can exist within the same process and share a common address space, while different processes do not share a common address space. In particular, the threads of a process share the process's instructions and the process's context (the values of various variables at any given moment). A thread of execution may include various subroutine calls, which are tracked in a call stack for thread.

A call stack, also referred to as an execution stack, control stack, function stack, or run-time stack, refers to a stack data structure that stores information describing active subroutines of a computer program. A call stack may be used for several related purposes, including tracking of the point to which each active subroutine is to return control when the subroutine finishes executing. Active subroutines are those which have been called but have not yet completed execution by returning.

A stack data structure is a LIFO (Last In, First Out) data structure in which elements are ‘pushed on’ the top of the stack and ‘popped off’ the top of the stack. The element that is popped off of (removed from) the stack is the last (most recent) element to be pushed on the stack.

Because the call stack is organized as a stack data structure, a caller of a subroutine pushes a return address onto the stack—in a stack frame described below—and the called subroutine, once completed, pops the return address off the call stack, transferring control to the return address. If a first called subroutine subsequently calls another subroutine, the first called subroutine will push another return address onto the call stack, and so on, with the information stacking up and unstacking as execution of the computer program dictates.

A call stack is composed of stack frames, sometimes called activation records. Each stack frame is a data structure, within the call stack, containing subroutine state information. Each stack frame corresponds to a call to a subroutine which has not yet terminated with a return. That is, each stack frame corresponds to an active subroutine. The first stack frame in the call stack—the ‘top’ frame of the stack, the most recently added stack frame—corresponds to the currently executing subroutine. A stack frame may include various data, including, for example: values of local variables of the subroutine, a return address back to the routine's caller, and parameter values passed to the subroutine.

Call stack inspection for a thread of execution in accordance with the present invention is generally implemented with computers, that is, with automated computing machinery. The system of FIG. 1 includes an example of such automated computing machinery, a computer (152) useful in call stack inspection for a thread of execution according to embodiments of the present invention. The computer (152) includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is an application program (126), a module of computer program instructions that carries out user-level data processing tasks. Examples of such application programs include word processing applications, spreadsheet creation and editing applications, multimedia library applications, multimedia playback applications, image, audio, or video editing applications, database management applications, web browsers, and any other types of application as will occur to readers of skill in the art. Also stored in RAM (168) is an operating system (154). An operating system is a computer software component that is responsible for execution of applications programs and for administration of access to computer resources, memory, processor time, and I/O functions, on behalf of application programs. Operating systems useful call stack inspection for a thread of execution according to embodiments of the present invention include UNIX™, Linux™, Microsoft XP™, AIX™, IBM's i™, and others as will occur to those of skill in the art.

The example operating system (154) in the system of FIG. 1 schedules threads for execution by the processor (156). In the system of FIG. 1, for example, the operating system (154) schedules a thread of the application program (126) for execution.

Also stored in RAM (168) is a call stack inspector (118), a module of computer program instructions improved for call stack inspection for a thread of execution according to embodiments of the present invention. The call stack inspector (118) may inspect the call stack iteratively—stack frame by stack frame—beginning at the first, also referred to as the ‘top,’ stack frame. For each stack frame (106-112) in the call stack (104), the call stack inspector (118) may inspect the stack frame (106) and determine whether the stack frame (106) was present in the call stack (104) on a previous inspection of the call stack (104). In inspecting a stack frame (106-112), the call stack inspector (118) may gather from the stack frame various data describing the stack frame—return address, size of the frame, local variables and variable values of the stack frame, and so on as will occur to readers of skill in the art. The call stack inspector (118) in the example of FIG. 1 is further configured to gather, from the stack frame itself, data indicating whether the stack frame was present on a previous inspection. If the stack frame (106) was not present on a previous inspection, the call stack inspector (118) may indicate in the stack frame (106) the stack frame's (106) presence on the current inspection of the call stack (104). The call stack inspector (118), for example, may indicate presence of a stack frame by setting a flag (114) in the stack frame (112). If the stack frame (106) was present on a previous inspection, the call stack inspector (118) may notify a user (101). Such a notification (116) may take many different forms. Several different user notifications are described below in further detail. In some embodiments, notifications (116) are provided to users (101) through a graphical user interface (102) presented on a display device (180).

The call stack inspector (118), application program (126), call stack (104), and operating system (154), in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for call stack inspection for a thread of execution according to embodiments of the present invention include Integrated Drive Electronics ('IDE') adapters, Small Computer System Interface (SCSI') adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for call stack inspection for a thread of execution according to embodiments of the present invention include modems for wired dial-up communications, Ethernet (IEEE 802.3) adapters for wired data communications network communications, and 802.11 adapters for wireless data communications network communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

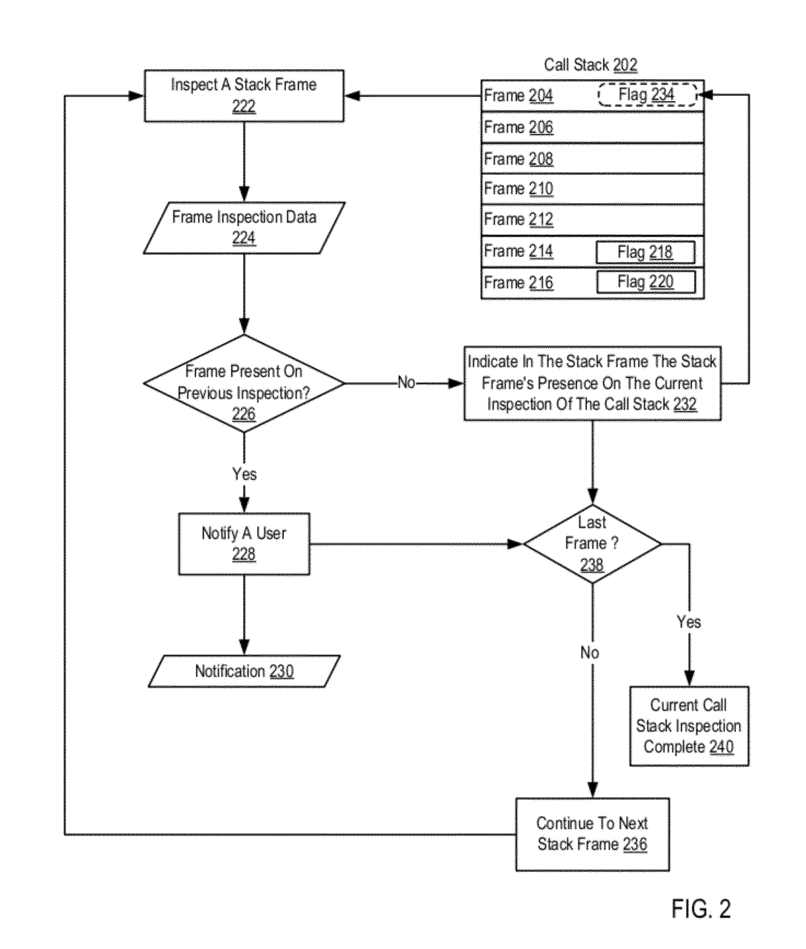

For further explanation, FIG. 2 sets forth a flow chart illustrating an exemplary method for call stack inspection for a thread of execution according to embodiments of the present invention. The method of FIG. 2 is carried out for each stack frame (204-216) in a call stack (202) of a thread of execution, beginning with a first stack frame (the ‘top’ frame).

The method of FIG. 2 includes inspecting (222) the stack frame (204). Inspecting (222) the stack frame (204) may be carried out by gathering, from the stack frame itself, frame inspection data (224) describing the stack frame (204). Such frame inspection data (224) may include, for example, values of variables of the subroutine corresponding to the stack frame, a return address of the caller of the subroutine, and so on as will occur to readers of skill in the art. Such frame inspection data may effectively include a ‘snapshot’ of the stack frame upon inspection. The frame inspection data (224) may also include a current program counter, global variables, and so on as will occur to readers of skill in the art.

The method of FIG. 2 also includes determining (226) whether the stack frame (204) was present in the call stack (202) on a previous inspection of the call stack (202). In embodiments of the present invention, stack frames may be configured with a inspection flag—a predefined bit in the stack frame, for example—that when set indicates presence of the stack frame upon a previous inspection. In such embodiments, stack frames, when pushed on the call stack, may be initialized without the flag being set. Determining (226) whether the stack frame (204) was present in the call stack (202) on a previous inspection of the call stack (202) may be carried out by determining whether the stack frame's inspection flag (218, 220, 234) is set. In the example call stack (202) of FIG. 2, the inspection flags of stack frames (204-212) are not set upon initiation of the current call stack inspection. The inspection flags (218 and 220) of stack frames (214 and 216), were set on a previous inspection, indication that stack frames (214 and 216) were present on a previous inspection of the call stack (202).

If the stack frame (204) was not present on a previous inspection, the method of FIG. 2 continues by indicating (232) in the stack frame (204) the stack frame's (204) presence on the current inspection of the call stack (202). Indicating (232) in the stack frame (204) the stack frame's (204) presence on the current inspection of the call stack (202) may be carried out by setting the stack frame's (204) inspection flag (234). In this way, stack frames present on the current inspection and not popped before a subsequent inspection may be identified (through the inspection flag) during the subsequent inspection.

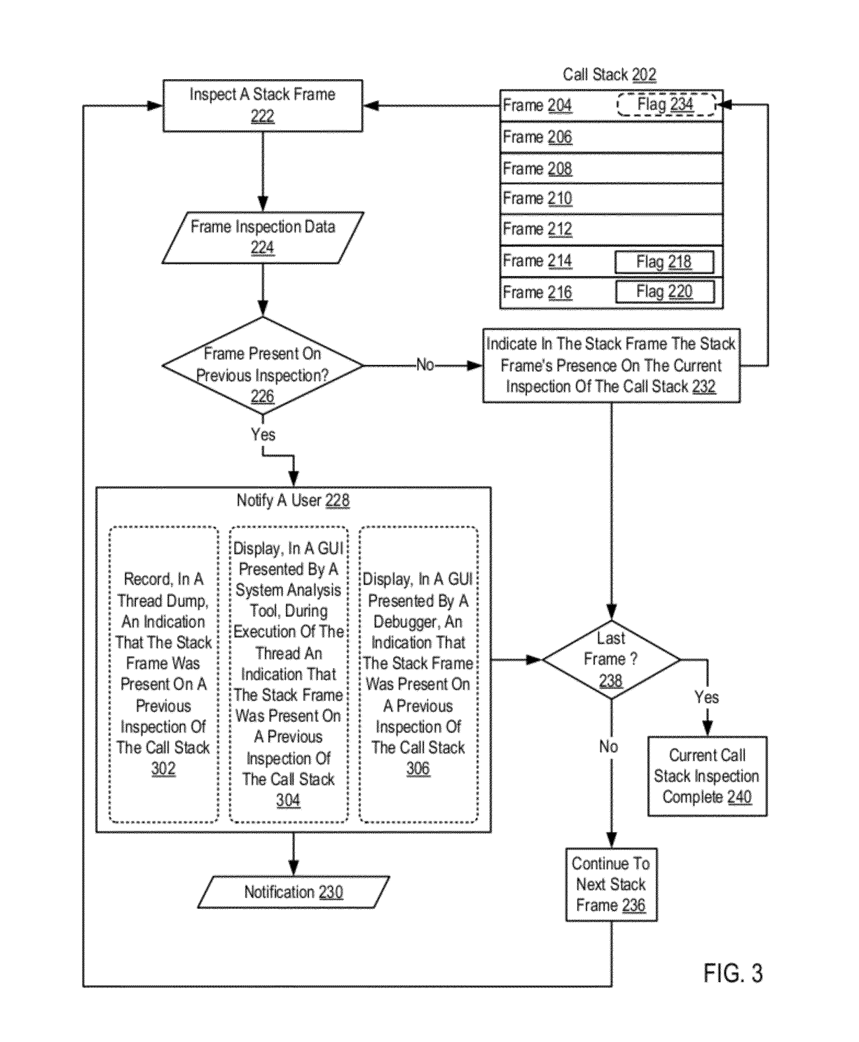

If the stack frame (204) was present on a previous inspection, the method of FIG. 2 continues by notifying (228) a user. Such a notification (230) may take many forms, some of which are described below with respect of FIG. 3. A notification (230) that a stack frame was present on a previous inspection, for example, may be an asterisk associated with a stack frame identifier in a call stack inspection report.

After notifying a user (228) that a stack frame was present on a previous inspection or indicating (232) in the stack frame the stack frame's presence on the current inspection, the method of FIG. 2 continues by determining (238) whether the stack frame under inspection is the last stack frame in the call stack. If the stack frame under inspection is the last stack frame in the call stack the current call stack inspection is complete (240). If, however, the stack frame under inspection is not the last stack frame in the call stack, the method of FIG. 2 continues (236) to the next stack frame to repeat the inspection (222) and determination (226). In this way, the method of FIG. 2 is carried out for each stack frame in the call stack, iteratively, beginning with a first stack frame and ending the current call stack inspection with the last stack frame of the call stack.

For further explanation, FIG. 3 sets forth a flow chart illustrating a further exemplary method of call stack inspection for a thread of execution according to embodiments of the present invention. The method of FIG. 3 is similar to the method of FIG. 2 in that the method of FIG. 3 is carried out for each stack frame (204-216) in a call stack (202) and includes inspecting (222) the stack frame (204); determining (226) whether the stack frame (204) was present in the call stack (202) on a previous inspection of the call stack (202); if the stack frame (204) was not present on a previous inspection, indicating (232) in the stack frame (204) the stack frame's (204) presence on the current inspection of the call stack (202); and if the stack frame (204) was present on a previous inspection, notifying (228) a user.

The method of FIG. 3 differs from the method of FIG. 2, however, in that in the method of FIG. 3, notifying (228) a user further includes recording (302), in a thread dump, an indication that the stack frame was present on a previous inspection of the call stack; displaying (304), in a GUI presented by a system analysis tool during execution of the thread, an indication that the stack frame was present on a previous inspection of the call stack; and displaying (306), in a GUI presented by a debugger, an indication that the stack frame was present on a previous inspection of the call stack.

Recording (302), in a thread dump, an indication that the stack frame was present on a previous inspection of the call stack may be carried out by recording the state of the thread including a snapshot of the call stack at the time the thread dump was generated and for each stack frame of the call stack present on a previous inspection of the call stack, marking the stack frame in the thread dump. Such a marking may include a predefined symbol, a predefined string character code, a predefined punctuation mark such as asterisk or an exclamation point, a markup language tag, and so on as will occur to readers of skill in the art.

Consider the following example thread dump:
Frame: at java/io/FileDescriptorsead(Native Method)
Frame: at java/io/FileDescriptor.read(FileDescriptor.java:55(Compiled Code))
Frame: at java/io/FileInputStream.read(FileInputStream.java:166(Compiled Code))
Frame: at java/io/DataInputStream.readInt(DataInputStream.java:382)
Frame: * at sun/plugin/navig/motif/Plugin.doit(Plugin.java:173)

The example thread dump above sets forth five stack frames of a currently executing thread, where one of the stack frames is indicated, with an asterisk, as being present upon a previous inspection (a previous thread dump).

As mentioned above, notifying (228) a user that a stack frame was present on a previous inspection of the call stack may also include displaying (304), in a GUI presented by a system analysis tool during execution of the thread, an indication that the stack frame was present on a previous inspection of the call stack. A system analysis tool as the term is a module of computer program instructions configured to inspect performance characteristics of a computer system—hardware performance, software performance, or both. In the example of FIG. 3, the system analysis tool is further configured to indicate whether a stack frame of a presently executing thread was present on a previous inspection. Such ‘inspections’ may take place at periodically at predefined time intervals. Consider, for example, that the system analysis tool presents a call stack monitor to user through a GUI in which display of the call stack monitor is refreshed every ten seconds. In this way, each refresh operates as a separate inspection of the call stack and any stack frame present on a previous refresh will be marked in the current refresh. In some analysis tools, presentation of a call stack monitor may be refreshed at the behest of the user.

As also mentioned above, notifying (228) a user that a stack frame was present on a previous inspection of the call stack may also include displaying (306), in a GUI presented by a debugger, an indication that the stack frame was present on a previous inspection of the call stack. A debugger is an application program that is used to test and debug other programs. Debuggers offer functions such as running a program step by step (single-stepping or program animation), stopping (breaking)—pausing the program to examine the current state—at some event or specified instruction by means of a breakpoint, and tracking the values of some variables. The debugger in the example of FIG. 3 may provide a display of the call stack in which stack frames present upon previous inspection of the call stack are marked. Such inspections may be initiated at a user's behest, upon a breakpoint, after each step of program execution, periodically during continuing execution of the program, and in other ways as will occur to readers of skill in the art.

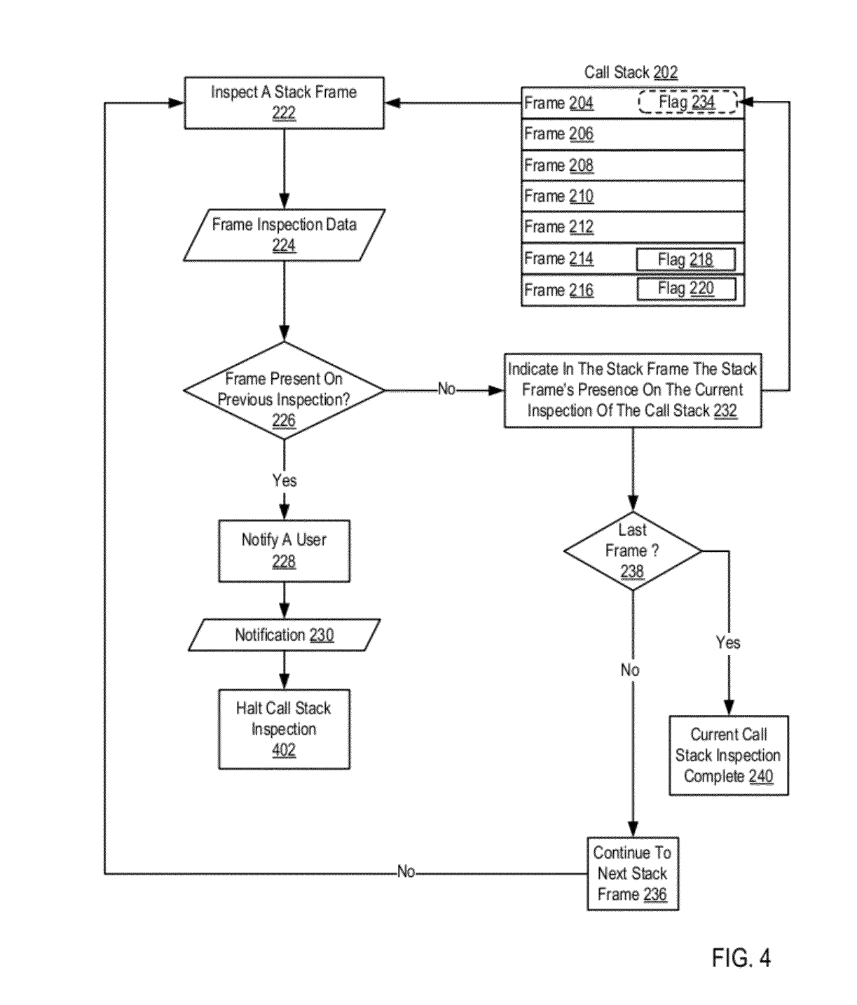

For further explanation, FIG. 4 sets forth a flow chart illustrating a further exemplary method of call stack inspection for a thread of execution according to embodiments of the present invention. The method of FIG. 4 is similar to the method of FIG. 2 in that the method of FIG. 4 is carried out for each stack frame (204-216) in the call stack (202), beginning with the stack frame (204) at the top of the call stack and includes inspecting (222) the stack frame (204); determining (226) whether the stack frame (204) was present in the call stack (202) on a previous inspection of the call stack (202); if the stack frame (204) was not present on a previous inspection, indicating (232) in the stack frame (204) the stack frame's (204) presence on the current inspection of the call stack (202); and if the stack frame (204) was present on a previous inspection, notifying (228) a user.

The method of FIG. 4 differs from the method of FIG. 2, however, in the method of FIG. 4 includes halting (402) call stack inspection upon discovery of a first stack frame in the call stack (202) present on a previous inspection. That is, rather than iterating stack frame by stack frame for each frame in the call stack until reaching the end of the call stack, the method of FIG. 4 halts when a first stack frame is discovered in the call stack that was present on a previous inspection. Due to the nature of the call stack as a stack data structure—LIFO data structure—anything below the first stack frame present on a previous inspection will also be a stack frame present on a previous inspection. As such, any frame inspection data (224) gathered from the first stack frame in the call stack present on a previous inspection and from stack frames below may be duplicative—gathered on a previous inspection. Halting call stack inspection upon discovering a first stack frame in the call stack present on a previous inspection may increase efficiency and speed of multiple call stack inspections by reducing the number of stack frames inspected during each inspection of the call stack. In this way, the method of FIG. 4 is an iterative process, beginning at the top stack frame (204) of the call stack (202) and ending upon encountering a stack frame present on a previous inspection, that is, stack frame (214).

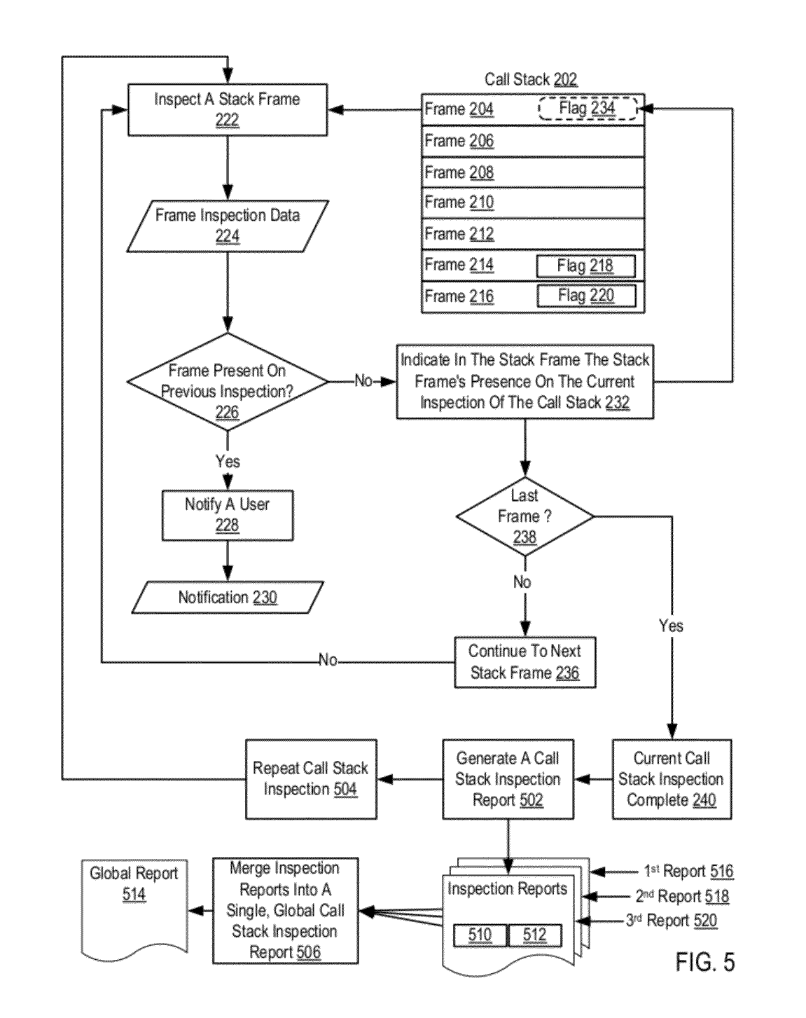

For further explanation, FIG. 5 sets forth a flow chart illustrating a further exemplary method of call stack inspection for a thread of execution according to embodiments of the present invention. The method of FIG. 5 is similar to the method of FIG. 2 in that the method of FIG. 5 is carried out for each stack frame (204-216) in a call stack (202) and includes inspecting (222) the stack frame (204); determining (226) whether the stack frame (204) was present in the call stack (202) on a previous inspection of the call stack (202); if the stack frame (204) was not present on a previous inspection, indicating (232) in the stack frame (204) the stack frame's (204) presence on the current inspection of the call stack (202); and if the stack frame (204) was present on a previous inspection, notifying (228) a user.

The method of FIG. 5 differs from the method of FIG. 2, however, the method of FIG. 5 also includes generating (502), upon completion (240) of the call stack inspection, a call stack inspection report (516, 518, 520) including in the report indications (510, 512) of stack frames (204-216) present on a previous inspection. Such a call stack inspection report may, for example, may be a thread dump.

The method of FIG. 5 continues by repeating (504) the call stack inspection a plurality of times, and generating (502) a plurality of call stack inspection reports (516, 518, 520). That is, each time the call stack is inspected, an inspection report is generated. In the method of FIG. 5, for example, three separate call stack inspections have been carried out, each generating an inspection report—a first inspection report (516) for a first call stack inspection, a second inspection report (518) for a second call stack inspection, and a third inspection report (520) for a third call stack inspection.

The method of FIG. 5 continue by merging (506) the plurality of call stack inspection reports (508) into a single, global call stack inspection report (514) in dependence upon indications (510, 512) of stack frames (204-216) present on a previous inspection in the plurality of call stack inspection reports. Merging inspection reports may be carried out in various ways, including by removing duplicate entries for stack frames in multiple inspection reports, leaving in the global report only unique stack frame entries or by merging incomplete stack reports—such as stack reports generated in the method of FIG. 4.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable transmission medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable transmission medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable transmission medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of call stack inspection for a thread of execution, the method comprising:
for each stack frame in the call stack, beginning with the stack frame at the top of the call stack:
inspecting the stack frame;
determining whether the stack frame was present in the call stack on a previous inspection of the call stack;
if the stack frame was not present on a previous inspection, indicating in the stack frame the stack frame's presence on the current inspection of the call stack; and
if the stack frame was present on a previous inspection, notifying a user.

2. The method of claim 1, wherein notifying a user further comprises recording, in a thread dump, an indication that the stack frame was present on a previous inspection of the call stack.

3. The method of claim 1, wherein notifying a user further comprises displaying, in a graphical user interface (‘GUI’) presented by a system analysis tool during execution of the thread, an indication that the stack frame was present on a previous inspection of the call stack.

4. The method of claim 1, wherein notifying a user further comprises displaying, in a graphical user interface (‘GUI’) presented by a debugger, an indication that the stack frame was present on a previous inspection of the call stack.

5. The method of claim 1, further comprising halting call stack inspection upon discovery of a first stack frame in the call stack present on a previous inspection.

6. The method of claim 1, further comprising:
generating, upon completion of the call stack inspection, a call stack inspection report including in the report indications of stack frames present on a previous inspection; and
repeating the call stack inspection a plurality of times, generating a plurality of call stack inspection reports; and
merging the plurality of call stack inspection reports into a single, global call stack inspection report in dependence upon indications of stack frames present on a previous inspection in the plurality of call stack inspection reports.

7. An apparatus for call stack inspection for a thread of execution, the apparatus comprising a computer processor, a computer memory operatively coupled to the computer processor, the computer memory having disposed within it computer program instructions capable, when executed by the computer processor, of causing the apparatus to carry out the steps of:
for each stack frame in the call stack, beginning with the stack frame at the top of the call stack:
inspecting the stack frame;
determining whether the stack frame was present in the call stack on a previous inspection of the call stack;
if the stack frame was not present on a previous inspection, indicating in the stack frame the stack frame's presence on the current inspection of the call stack; and
if the stack frame was present on a previous inspection, notifying a user.

8. The apparatus of claim 7, wherein notifying a user further comprises recording, in a thread dump, an indication that the stack frame was present on a previous inspection of the call stack.

9. The apparatus of claim 7, wherein notifying a user further comprises displaying, in a graphical user interface (‘GUI’) presented by a system analysis tool, an indication that the stack frame was present on a previous inspection of the call stack.

10. The apparatus of claim 7, wherein notifying a user further comprises displaying, in a graphical user interface (‘GUI’) presented by a debugger, an indication that the stack frame was present on a previous inspection of the call stack.

11. The apparatus of claim 7, further comprising computer program instructions capable, when executed by the computer processor, of causing the apparatus to carry out the step of halting call stack inspection upon discovery of a first stack frame in the call stack present on a previous inspection.

12. The apparatus of claim 7, further comprising computer program instructions capable, when executed by the computer processor, of causing the apparatus to carry out the steps of:
generating, upon completion of the call stack inspection, a call stack inspection report including in the report indications of stack frames present on a previous inspection; and
repeating the call stack inspection a plurality of times, generating a plurality of call stack inspection reports; and
merging each call stack inspection report into a single, global call stack inspection report in dependence upon indications of stack frames present on a previous inspection in the plurality of call stack inspection reports.

13. A computer program product for call stack inspection for a thread of execution, the computer program product disposed upon a computer readable medium, the computer program product comprising computer program instructions capable, when executed, of causing a computer to carry out the steps of:
for each stack frame in the call stack, beginning with the stack frame at the top of the call stack:
inspecting the stack frame;
determining whether the stack frame was present in the call stack on a previous inspection of the call stack;
if the stack frame was not present on a previous inspection, indicating in the stack frame the stack frame's presence on the current inspection of the call stack; and
if the stack frame was present on a previous inspection, notifying a user.

14. The computer program product of claim 13, wherein notifying a user further comprises recording, in a thread dump, an indication that the stack frame was present on a previous inspection of the call stack.

15. The computer program product of claim 13, wherein notifying a user further comprises displaying, in a graphical user interface (‘GUI’) presented by a system analysis tool, an indication that the stack frame was present on a previous inspection of the call stack.

16. The computer program product of claim 13, wherein notifying a user further comprises displaying, in a graphical user interface (‘GUI’) presented by a debugger, an indication that the stack frame was present on a previous inspection of the call stack.

17. The computer program product of claim 13, further comprising computer program instructions capable, when executed, of causing a computer to carry out the step of halting call stack inspection upon discovery of a first stack frame in the call stack present on a previous inspection.

18. The computer program product of claim 13, further comprising computer program instructions capable, when executed, of causing a computer to carry out the steps of:
generating, upon completion of the call stack inspection, a call stack inspection report including in the report indications of stack frames present on a previous inspection; and
repeating the call stack inspection a plurality of times, generating a plurality of call stack inspection reports; and
merging each call stack inspection report into a single, global call stack inspection report in dependence upon indications of stack frames present on a previous inspection in the plurality of call stack inspection reports.

19. The computer program product of claim 13 wherein the computer readable medium comprises a storage medium.

20. The computer program product of claim 13 wherein the computer readable medium comprises a transmission medium.
